(19) United States
(12) Patent Application Publication
(10) Pub. No.: US 2015/0078136 A1
(43) Pub. Date: Mar. 19, 2015

(54) Conformable Transducer With Self Position Sensing

(71) Applicants: Mitsubishi Heavy Industries, Ltd., Tokyo (JP); Sikorsky Aircraft Corporation, Stratford, CT (US)

(72) Inventors: Fanping Sun, Glastonbury, CT (US); Zaffir A. Chaudhry, South Glastonbury, CT (US); Masaaki Kurokawa, Takasago (JP)

(73) Assignees: Mitsubishi Heavy Industries, Ltd., Tokyo (JP); Sikorsky Aircraft Corporation, Stratford, CT (US)

(21) Appl. No.: 14/026,248

(22) Filed: Sep. 13, 2013

(51) Int. Cl. H04R 17/00

(52) U.S. Cl. CPC H04R 17/00
USPC 367/180

(57) ABSTRACT

Embodiments are directed to a diaphragm-based flexible array comprising a plurality of piezoelectric elements, wherein the array is configured to conform to a surface of a structure under evaluation and emit acoustic waves in two directions in sequence, a source configured to apply a voltage pulse to each element of the array, and a sensor configured to receive an acoustic pulse from each element of the array in response to application of the voltage pulse to each element of the array.

### BACKGROUND

A phased array ultrasonic transducer (PAUT) may use multiple acoustic wave generation elements and time delays (e.g., electronic time delays) to create focused beams by constructive and destructive interference. A PAUT may be used to perform an evaluation (e.g., an ultrasonic nondestructive evaluation (NDE)) of a structure, such as an aerospace composite structure. The evaluation may be conducted to characterize the structure or perform maintenance.

A PAUT is able to steer and focus a sound beam through a range of angles and focal depths without having to physically move the transducer. However, adapters with variable geometry are required to inspect a structure with three-dimensional curved surfaces to ensure a good coupling of the acoustic beams. Existing conformable transducers include an individual mechanical spring loading for each array element, resulting in bulky and complex transducers with moving parts and limited spatial and frequency resolution.

### BRIEF SUMMARY

An embodiment of the disclosure is directed to a transducer comprising: a diaphragm-based flexible array comprising a plurality of piezoelectric elements, wherein the array is configured to conform to a surface of a structure under evaluation and emit acoustic waves in two directions in sequence, a source configured to apply a voltage pulse to each element of the array, and a sensor configured to receive an acoustic pulse from each element of the array in response to application of the voltage pulse to each element of the array.

An embodiment of the disclosure is directed to a method comprising: sensing, by a sensor, an arrival time of an acoustic pulse for each element of a flexible piezoelectric composite array when the array is in a reference position based on an excitation using a voltage pulse, conforming each element of the array to a surface of a structure under evaluation, exciting each of the elements a second time with the voltage pulse subsequent to conforming each element of the array to the surface of the structure under evaluation, sensing, by the sensor, a second arrival time of a second acoustic pulse for each element subsequent to conforming the array to the surface of the structure under evaluation, and calculating a change in a deflection that provides a conformable position for each element based on the arrival times.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 is a diagram of an exemplary transducer in accordance with one or more embodiments of this disclosure;

FIG. 2A illustrates exemplary lower electrodes in accordance with one or more embodiments of this disclosure;

FIG. 2B illustrates exemplary upper electrodes in accordance with one or more embodiments of this disclosure;

FIG. 3A illustrates an exemplary conforming of a transducer pneumatically to a concave surface in accordance with one or more embodiments of this disclosure;

FIG. 3B illustrates an exemplary conforming of a transducer pneumatically to a convex surface in accordance with one or more embodiments of this disclosure;

FIG. 4 illustrates an exemplary environment for determining a conformed position of an array in accordance with one or more embodiments of this disclosure; and

FIG. 5 is a flow chart of an exemplary method in accordance with one or more embodiments of this disclosure.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems, and methods are directed to a transducer (e.g., a phased array ultrasonic transducer (PAUT)) that possesses a solid state adaptive contact surface and is able to conform to a concave or convex contour by force—. In some embodiments, a transducer may determine a position of one or more sensors or sensing elements in an array, such as when the transducer conforms to, or is coupled to, a curved surface and its contour changes with spatial scanning. The position may be determined without a large number of displacement sensors.

In some embodiments, a solid state conformable phase array ultrasonic transducer (CPAUT) may be configured to determine positions associated with a conformed array. A transducer may be configured to achieve surface conformability via a structurally compliant piezoelectric composite matrix, an elastomeric backing, and a non-constraining connecting wire configuration. In some embodiments, the transducer may conform to a curved surface by assistance of, or via an application of, pneumatic force or pressure.

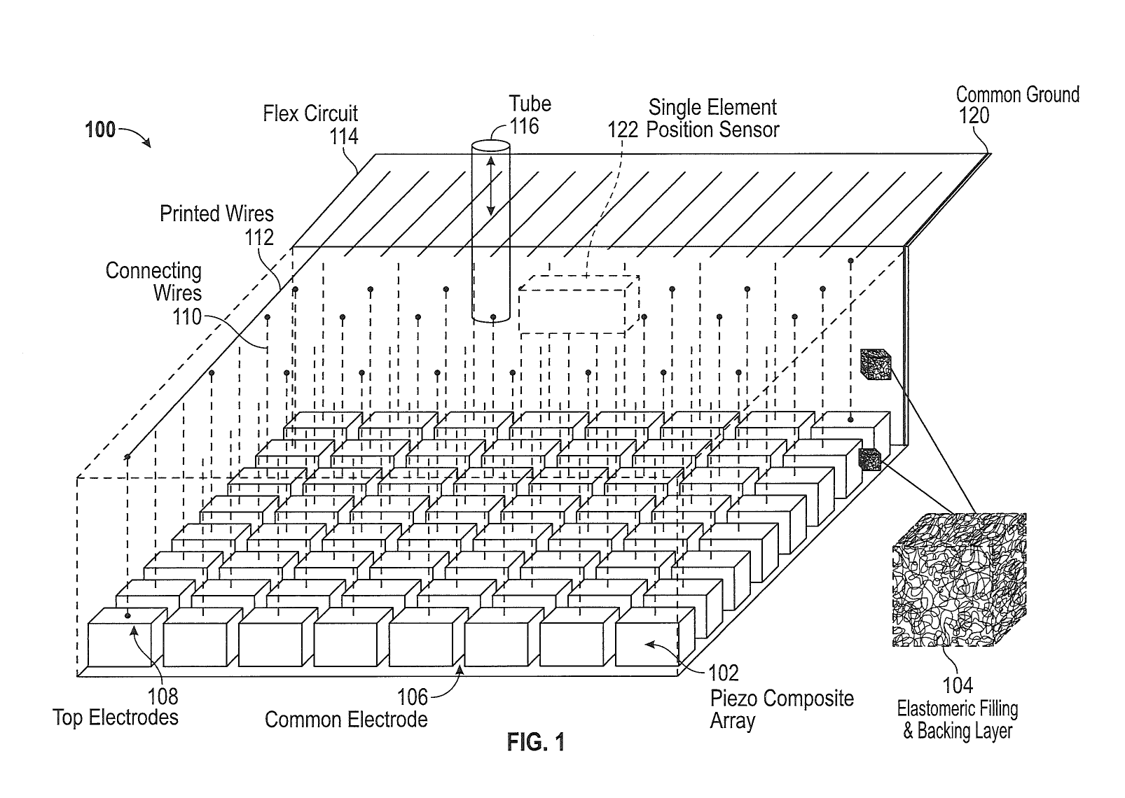

Turning to FIG. 1, an exemplary transducer 100 in accordance with one or more embodiments is shown. The transducer 100 may correspond to a CPAUT. As shown in FIG. 1, the transducer 100 may include a piezo-composite array 102. The array 102 is illustratively shown as being composed of cubes, although other geometric shapes may be used in some embodiments.

The array 102 may be integrated with a flexible thin film as a front layer of the transducer 100 and a soft elastomer as its backing layer, examples of which are denoted as 104 in FIG. 1. The front layer may be composed of one or more materials. For example, the front layer may be made of patterned polyimide and copper foil laminate and may serve as a structural support to the array elements 102 as well as a common (lower) ground electrode 106 for the array elements 102.

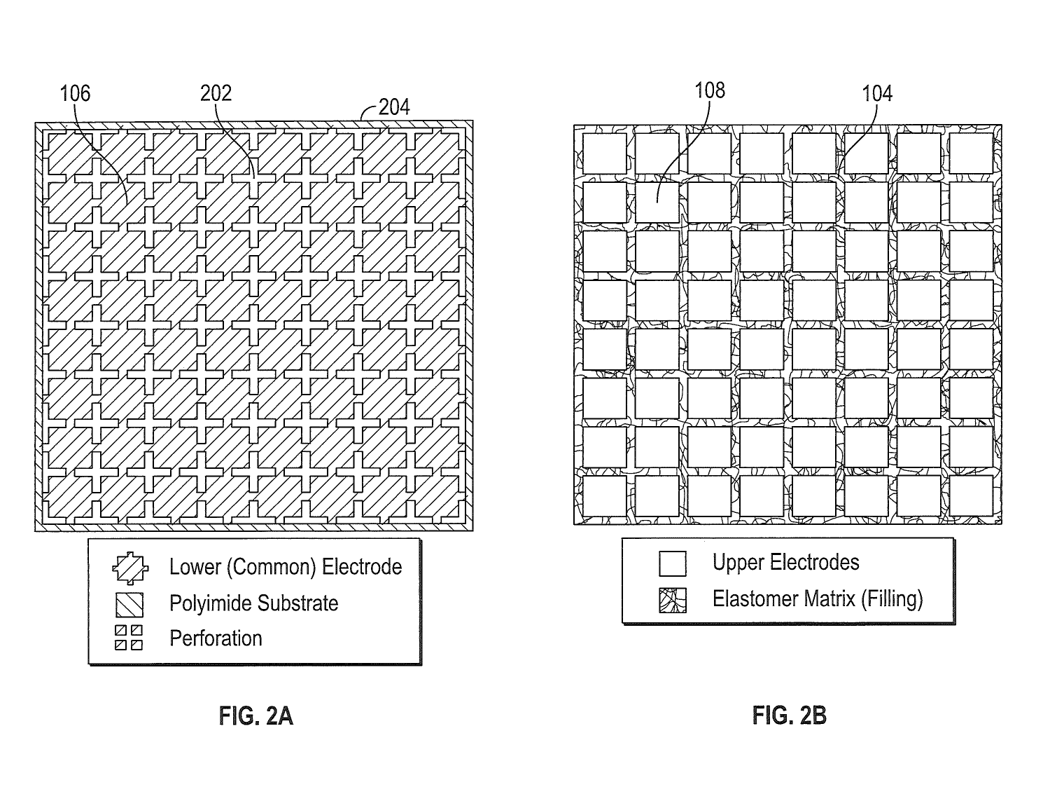

Referring briefly to FIG. 2A, a view of the electrode 106 is shown. Two-dimensional conformability of the array 102 may be provided by the patterned perforation of the laminate in the form of crosses 202 around the corners of each piezo cube. A polymide substrate 204 is shown around the perimeter.

Referring back to FIG. 1, the transducer 100 may include upper or top electrodes 108. A bird's eye view of the upper electrodes 108 is shown in FIG. 2B. The elastomer filling 104 may be used to provide structural reinforcement to the array 102.

An upper electrode 108 of each array element 102 may be individually wired 110 so that an alternating electric voltage of independent phase delay can be applied to it. The wires 110 may be coupled to printed wires 112, which may be used to convey information or data to or from a separate device or circuit (not shown), such as a controller (e.g., an pulse voltage generator and/or receiver). The information or data may be conveyed via a flex circuit 114, which may include one or more mediums such as a cable to connect to the controller. In this regard, the flex circuit 114 may include one or more connectors. The flex circuit 114 may be used in instances where the array 102 includes a large number of elements and may help make the transmission of data or information more manageable.

The transducer 100 may include a tube 116. The tube 116 may be used to apply positive pressure or negative pressure (e.g., a vacuum) to one or more elements of the array 102 in order to conform to a surface of a structure under evaluation as described further below. In some embodiments, the tube 116 may operate based on pneumatics.

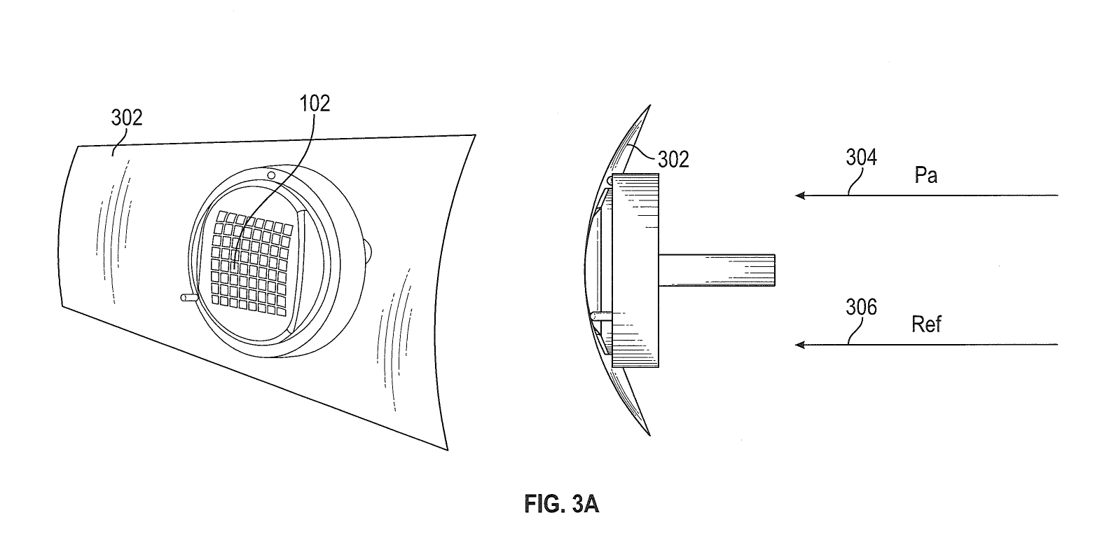

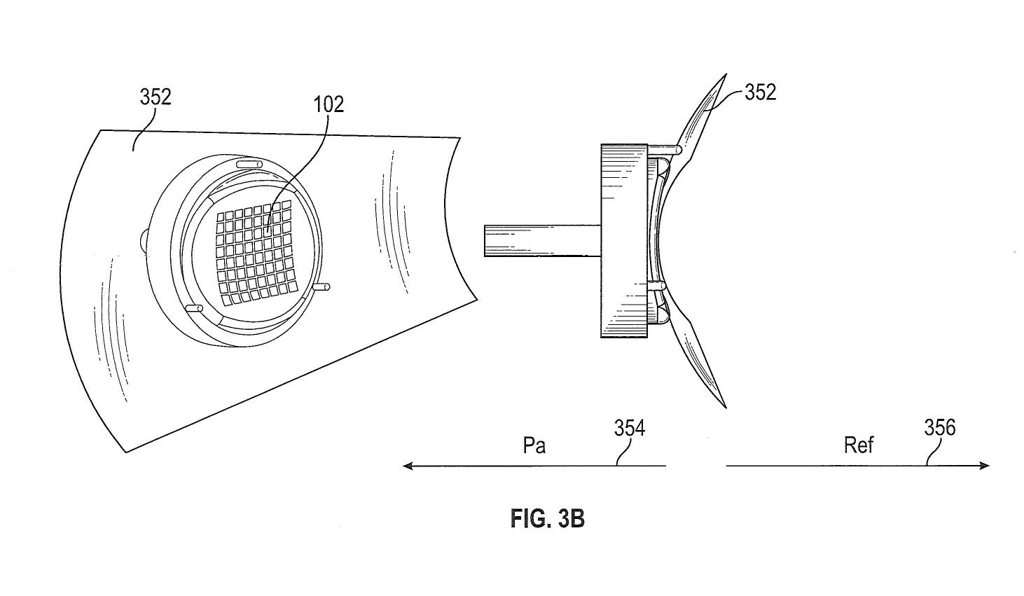

A conforming of the array 102 to a contour or shape of a structure subject to inspection (e.g., NDE inspection) may be provided via an adjustment of pressure (e.g., pneumatic pressure) behind the array 102. As shown in FIG. 3A, the array 102 may protrude and conform to a concave surface 302 when a pressure (Pa) 304 is applied that is positive with respect to a reference direction 306. As shown in FIG. 3B, the array 102 may yield to a convex surface 352 when the applied pressure (Pa) 354 is negative (e.g., corresponding to application of a vacuum) with respect to a reference direction 356.

For the transducer 100 to perform an automatic spatial scanning and depth focusing, the positions of each sensor or sensing element 102 may be instantaneously determined and updated as the transducer 100 scans a surface (e.g., surfaces 302 and 352 of FIGS. 3A and 3B). In some embodiments, acoustic ranging may be used to determine the positions.

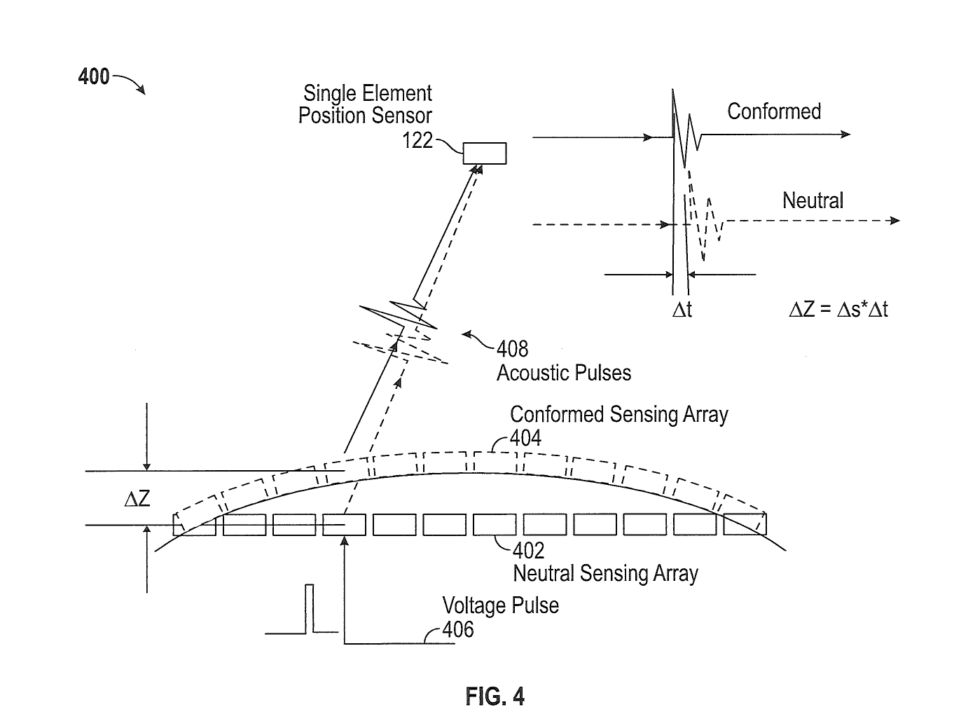

Referring to FIGS. 1 and 4, an exemplary environment 400 for determining a conformed position of the array 102 is shown. Specifically, as shown in FIG. 4, the array 102 is shown in a first or neutral sensing position 402 at a first scanning location, and a second or conformed sensing position 404 at a second scanning location. The neutral position 402 may correspond to a condition of no applied pneumatic pressure (e.g., Pa =0).

Each sensing element 102 in the array may be excited by a ranging voltage pulse 406 and may generate and emit an acoustic pulse 408 in response to the applied voltage pulse 406. The acoustic pulse 408 may be received by a piezoelectric sensor 122, which may be located in proximity to (e.g., within a threshold distance of), or over the top of, the array 102.

An arrival time (t₂) of an acoustic pulse 408 at the sensor 122 associated with a given element 102 when in the conformed position 404 may be compared to an arrival time (t₁) of an acoustic pulse 408 at the sensor 122 associated with that same element 102 when in the neutral position 402 to calculate a change in distance or deflection ΔZ. As shown in FIG. 4, the change in distance ΔZ from the neutral position 402 to the conformed position 404 for a given element 102 may be calculated using equation #1 as follows:

ΔZ=Vs*Δt, equation #1

where Vs may be the speed of the acoustic pulses 408 (which may be approximately constant for a given medium or material), and Δt may be equal to the difference in time (e.g., t₂-t₁) for the pulses 408 to arrive at the sensor 122 in the conformed position 404 relative to the neutral position 402. While described above in the context of scalars, vector quantities may be used for purposes of providing directional information as well.

The calculation of equation #1 may be repeated for each element of the array 102 by scanning (e.g., sequentially scanning) each element of the array 102, and a deflection map may be generated for the array 102. The map may be updated each time the transducer 100 moves a step forward along an inspection scan axis.

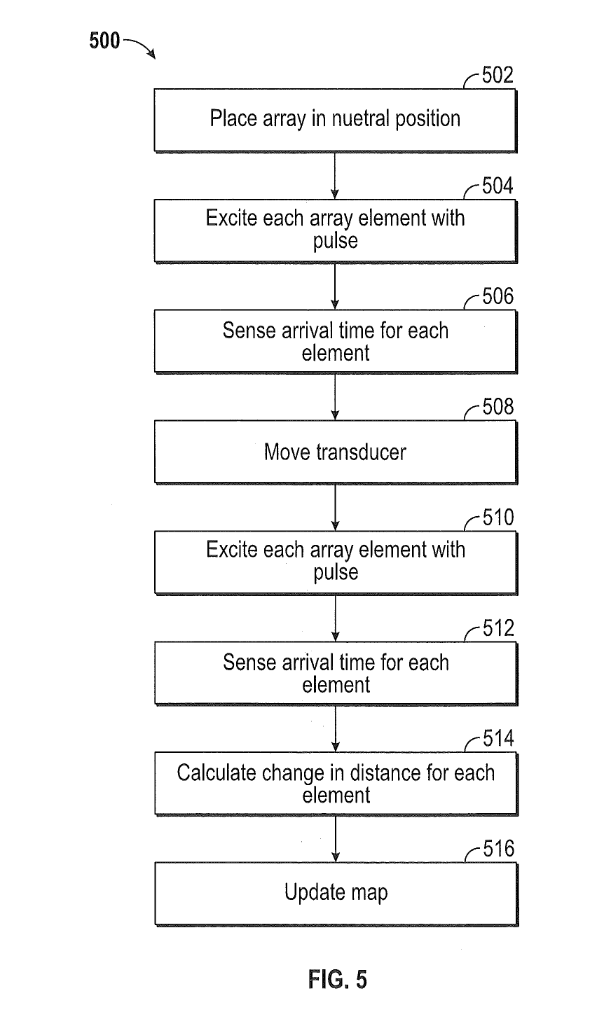

Turning to FIG. 5, a flow chart of a method 500 is shown. The method 500 may be executed in connection with one or more components, devices, or systems, such as those described herein. The method may be used to determine an instantaneous position of one or more sensors or sensing elements in an array of a transducer.

In block 502, the array may be in a first or neutral position (e.g., position 402 of FIG, 4). In some instances, the neutral position may correspond to application of the transducer to a flat surface or structure. The neutral position may correspond to a reference position for purposes of comparison.

In block 504, each element of the array, while in the neutral position may be excited with a pulse (e.g., a voltage pulse) from a source (e.g., a voltage source). Each element may be excited in turn with the pulse, such that the pulse may be applied to each element on an individual basis.

In block 506, an arrival time of an acoustic pulse for each of the array elements may be sensed in response to the application of the voltage pulse in block 504.

In block 508, the transducer may be moved. For example, the transducer may be moved a step forward along an inspection axis associated with a surface. As a result of the movement, the positions of the array elements may be modified relative to the neutral position of block 502. For example, the movement of the transducer in block 508 may cause the array elements to take on a conformed profile or position (e.g., position 404 of FIG, 4).

Following the movement of the transducer in block 508, in block 510 each element of the array may be excited with the pulse. In order to provide for a meaningful comparison, the pulse applied in block 510 may have the same characteristics (e.g., type, amplitude, duration, etc.) as the pulse that is applied in block 504.

In block 512, an arrival time of an acoustic pulse for each of the array elements may be sensed in response to the application of the voltage pulse in block 510.

In block 514, a change in distance or deflection for each of the array elements may be calculated. The calculation of block 514 may be performed using equation #1 described above, and may be based on the sensed arrival times 506 and 512.

In block 516, a deflection map of the array may be updated based on the calculation of block 514.

In some embodiments, one or more of the blocks or operations (or a portion thereof) of the method 500 may be optional. In some embodiments, the blocks may execute in an order or sequence different from what is shown in FIG. 5. In some embodiments, one or more additional blocks or operations not shown may be included.

Embodiments of the disclosure may include a CPAUT that may be configured to generate a seamless surface contact with a structure under evaluation or test. The CPAUT may eliminate a need for adaptive loading that requires a complex spring mechanism. The CPAUT may provide for a compact and no-moving-part design of a very fine two dimensional array, resulting in enhanced frequency, spatial resolution, and signal-to-noise ratio (SNR). Pneumatic assisted adaptability may improve NDE reliability and test efficiency on structures with one or more complex surfaces (e.g., complex geometrical surfaces), such as a composite helicopter blade. The use of a common phase array matrix for ranging may enable a determination of a position, shape, or profile of the conforming surface and may eliminate a need for a bulky and complex on-board motion sensors array. Low cost volume production may be provided.

Embodiments of this disclosure may be tied to one or more particular machines. For example, a transducer may include an array of sensors or sensing elements. The array may conform to a surface that the transducer is in contact with, potentially via the use of a solid state adaptive contact surface. A position sensor may be configured to determine a position or location of the sensing elements of the array.

Aspects of this disclosure may be applied to aircraft and aerospace environments or applications, such as a manufacturing and/or inspection of aircraft composite components and devices, or a portion thereof. Aspects of this disclosure may be applied to other environments or applications. For example, aspects of this disclosure may be adapted so as to be applied to marine applications (e.g., boat, ship, submarine), terrestrial or vehicular applications (e.g., automotive applications), power generation and maintenance (e.g., power plant welding, such as nuclear power plant welding), etc.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A transducer comprising:
a diaphragm-based flexible array comprising a plurality of piezoelectric elements, wherein the array is configured to conform to a surface of a structure under evaluation and emit acoustic waves in two directions in sequence;
a source configured to apply a voltage pulse to each element of the array; and
a sensor configured to receive an acoustic pulse from each element of the array in response to application of the voltage pulse to each element of the array.

2. The transducer of claim 1, wherein the elements of the array are shaped as cubes and plates.

3. The transducer of claim 1, wherein the array is integrated with a flexible thin film as a front layer and a soft elastomer as a backing layer.

4. The transducer of claim 3, wherein the front layer is made of patterned polyimide and copper foil laminate, and wherein the front layer is configured to serve as a common ground electrode for the array.

5. The transducer of claim 4, wherein the laminate comprises a patterned perforation in the form of crosses.

6. The transducer of claim 1, wherein each element of the array comprises an upper electrode that is individually wired.

7. The transducer of claim 1, wherein the array is configured to conform to the surface of the structure under evaluation via an adjustment of pneumatic pressure.

8. The transducer of claim 1, wherein the source is configured to sequentially apply the voltage pulse to each element of the array.

9. The transducer of claim 1, wherein the transducer is configured to determine a profile of the surface of the structure under evaluation based on receipt of two acoustic pulses from each element of the array, wherein a first of the two acoustic pulses is generated when the array is in a reference position, and wherein a second of the two acoustic pulses is generated when the array conforms to the surface of the structure.

10. A method comprising:
sensing, by a sensor, an arrival time of an acoustic pulse for each element of a flexible piezoelectric composite array when the array is in a reference position based on an excitation using a voltage pulse;
conforming each element of the array to a surface of a structure under evaluation;
exciting each of the elements a second time with the voltage pulse subsequent to conforming each element of the array to the surface of the structure under evaluation;
sensing, by the sensor, a second arrival time of a second acoustic pulse for each element subsequent to conforming the array to the surface of the structure under evaluation; and
calculating a change in a deflection that provides a conformable position for each element based on the arrival times.

11. The method of claim 10, further comprising:
adjusting a pneumatic pressure to conform the elements of the array to the surface of the structure under evaluation.

12. The method of claim 10, further comprising:
determining a profile of the surface of the structure under evaluation based on the calculated change in deflection for each array element.

13. The method of claim 10, further comprising:
updating a deflection map of the array responsive to a movement along an axis of a transducer associated with the array.

14. The method of claim 10, wherein the structure under evaluation comprises at least a portion of an aircraft

15. The method of claim 10, wherein the surface of the structure under evaluation comprises a curved surface.

16. The method of claim 15, wherein the curved surface comprises a concave surface with respect to the conformed elements of the array.

17. The method of claim 15, wherein the curved surface comprises a convex surface with respect to the conformed elements of the array.
